(19) United States
(12) Patent Application Publication
(10) Pub. No.: US 2025/0109626 A1
(43) Pub. Date: Apr. 3, 2025

(54) ADAPTIVE THRESHOLD FOR SLIDING DOORS

(71) Applicant: WINGECO SRL, Genova (IT)

(72) Inventors: Marco CORBANI, Genova (IT); Alberto MALATESTA, Genova (IT); Andrea APPOLONI, Recco (IT)

(21) Appl. No.: 18/863,464

(22) PCT Filed: May 4, 2023
(86) PCT No.: PCT/IT2023/050117

§ 371 Date: Nov. 6, 2024

(30) Foreign Application Priority Data
May 9, 2022 (IT) 102022000009491

(51) Int. Cl. E06B 1/70

(52) U.S. Cl. CPC E06B 1/70

(57) ABSTRACT

The patent consists of a flap which can be employed for covering the cavity corresponding to the lower profile of a sliding window when the sash opens. Said system subsequently allowing automatic withdrawal of said flap in a side-by-side position and not interfering with the sliding of said door during closing: said automatic withdrawal thus taking place in correspondence with the sliding in the opposite direction of the same door. This double synchronized movement with opening and closing of said sliding door favors the crossing of the threshold by users but above all by wheelchairs, trolleys, pushchairs and similar. The system object of the patent proposal is based on a mechanism controlled directly by the sliding of said sliding door which allows the automatic movement of said flap from a first horizontal position covering the frame track to a second lateral position next to the sliding door and vice versa.

### TECHNICAL FIELD

The present invention relates to the window and door product sector and particularly to systems and devices which in said context are used to eliminate and/or mitigate architectural barriers and/or limitations to the usability and ease of use of a door or window. In particular, the proposed invention can be applied to a particularly widespread and well-known type of door or window frame, such as the so-called sliding doors, and consists of a folding threshold which can be conveniently used to close the lower cavity which often characterizes said window frames. Said aid is particularly advantageous for facilitating the passage of devices and vehicles equipped with wheels: primarily and mainly wheelchairs for the disabled but also pushchairs, trolleys, transport trolleys and similar. Said folding threshold system is profitably usable in the window and door market both as an improvement that can be integrated into newly constructed sliding doors and as a remedy for existing and traditionally shaped doors.

### BACKGROUND ART

Generally, sliding door assemblies comprise a sliding door panel which, guided longitudinally, slides parallel to a vertical wall between two extreme and opposite opening positions. Rotating members or support trolleys are usually fixed to said panel, which are then engaged in a sliding rail and support the weight of the panel as well as allowing it to move.On the side opposite to that of the support trolleys there are usually guide members, one part of which is fixed to the wall or floor and one part of which is fixed to the panel, said guide members allow the panel to remain in its vertical plane parallel to the wall vertical itself.

In view of the aforementioned configuration of a purely scholastic nature but reported for explanatory and non-limiting purposes only, the sliding doors have over time been subject to a gradual technical evolution which has progressively increased their structural complexity in particular by adding various thermal sealing systems rather than sealing against atmospheric agents such as air, water or wind and, furthermore, numerous automatisms have been developed which regulate automatic opening and closing.

Parallel to this technological evolution, also from a legislative point of view, there has been an evolution of the regulations concerning the fixtures and determining their types and construction constraints; these modalities pertaining not only to strictly technical requirements but also to employment directives concerning the so-called architectural barriers.

Given the aforementioned technical and regulatory evolution, the presence of a rail in this type of sliding door and window implies problems both in terms of resistance to atmospheric agents and in terms of the usability of the window itself and particularly by people with disabilities; especially by those who move or ambulate using aids such as wheelchairs or trolleys equipped with wheels. In these circumstances, the presence of a rail obviously makes it inconvenient to cross the threshold, this inconvenience being particularly accentuated in the case of devices equipped with small wheels (typically directional) which can, in the worst case, get stuck in the cavity of said rail, causing not only inconvenience but also danger to people's safety.

Furthermore, said problem mentioned primarily and dutifully for disabled people also constitutes an inconvenience, albeit manageable, in the event that the window threshold is crossed by able-bodied people who move wheel-based devices such as, by way of non-limiting example, strollers for children rather than trolley or carts.

Over time, various solutions have been developed and proposed which can be applied to a sliding window in order to facilitate crossing the threshold; said solutions typically focusing on accessory ramps and slides used to go beyond the track of said frame.

These include patents JP 2015 218494 A (YOKOBIKI SR CO LTD), US 2010/064590 Al (JONES TOBY [US] ET AL); KR 101 989 553 B1 (KIM YOUNG WON [KR]); JP 7 039425 B2 (LIXIL CORP).

Said solutions being based on automatisms, slides or accessory ramps and constituting autonomous elements typically applied near the window and used when necessary or permanently by activating them separately; said actuation being piloted by means of a specific command, be it mechanical or electronic or by means of the handle of the window which allows, depending on how it is moved, to activate said slides rather than being traditionally used for opening and closing the window.

The use of accessory aid systems such as ramps and slides currently used to cover the sliding track of a sliding door is certainly positive but still presents various inconveniences, first of all the fact of requiring a multiplicity of separate operations with respect to the frame (opening/closing with separate activation of the aid); said drives having to be activated and coordinated by the user for their correct functioning and synchronism.

This peculiarity obviously implies difficulty of use by people with reduced mobility but also by able-bodied people who are simply not used to operating sliding doors subject to multiple operations and to be coordinated, under penalty of blockages or malfunctions or jams, etc. Furthermore, the sliding doors of new conception and production that aim at the removal of architectural barriers naturally and understandably evolve towards automatic operation (for example with the aid of built-in motors) so that the coordination of a plurality of automatisms pertaining to different problems it can cause coordination and mechanical synchronization problems between different elements and drives. In particular, it must be kept in mind that the necessary and understandable desire to cover the sliding track of a door in order to facilitate crossing the threshold must not affect the necessary sliding dynamics of the door with respect to said track or its resistance to atmospheric agents (if anything strengthen these aspects) and should further coordinate in a timely, reliable and synchronized manner with the common opening and closing operations of the window with good repeatability and reliability of the closure and without increasing the complexity of use of the window.

Finally, it should be noted that the solutions currently on the market are difficult to standardize or at least scalable and adaptable since they require a rather invasive adaptation of the window with modifications involving several elements: not only the track to be covered but often also the mobile leaf or the profiles or the drives. This resulting in devices that are scarcely usable as remedies for existing doors and have a significant impact also for their insertion (ad hoc with appropriate design and modifications) in newly built doors.

The proposed patent achieves the aforementioned objectives through a system with an adaptive threshold in the form of a flap that allows the cavity corresponding to the lower profile of a sliding window to be covered in correspondence with the opening of the sash. Said system subsequently allowing automatic withdrawal of said flap in a side-by-side position and not interfering with the sliding of said door during closing; said automatic withdrawal thus taking place in correspondence with the sliding in the opposite direction of the same door. This double synchronized movement with opening and closing of said sliding door favors the crossing of the threshold by users but above all by wheelchairs, trolleys, pushchairs and similar solutions.

The system referred to in the proposed patent being based on a leverage driven directly by the sliding of said sliding sash which allows automatic movement of said flap from a first horizontal position covering the rail of the frame to a second lateral position alongside the sash sliding, said second position allowing the sash to slide adequately and synchronously along the track when the window is closed. Said flap being subsequently able to return by gravity to the position of cover of the track following the opening of the window, i.e. if the sliding sash returns to its fully open position. Said movements of passage from said first cover position of the track to said second sliding position of the sash in the closing phase and vice versa being synchronized by means of a striker anchored to the sliding sash which in its opening and closing movement of the sash determines whether or not this leverage is energized. Said leverage being based on a telescopic mechanism which converts the kinetic energy produced by the advancement of the sash in the closing phase into a vertical movement of a thrust pin which lifts said flap and determines its overturning from the horizontal position covering the track to an oblique and lateral position to the leaf (in favor of gravity for the subsequent return); said position easily and synchronously allowing the sliding of said leaf towards the completely closed position.

Both of these synchronized movements of sash opening with the flap falling by gravity and of sash closing with lifting of the flap in a retracted position and not interfering with lateral sliding, being connected only to the dynamics of movement of the sliding sash regardless of the propulsive and drive modes of the same: both a manual push by a user, and the electromechanical operation of a possible automation system.

### DISCLOSURE OF INVENTION

The present patent intends to overcome the critical points set out above by means of an additional threshold which can be folded down if necessary and which can be conveniently used for covering/closing the lower cavity which characterizes said frames. Said folding threshold operating synchronously with the normal opening and closing of the window and as a result of these actions causing the closure of the cavity to facilitate passage or the overturning/opening of said threshold in a suitable position, not interfering with the sliding of the sash. A further purpose of the patent is to create a system which does not require separate drives and whose operation is controlled automatically and solely as a function of the movement of the sliding leaf only; said operation being therefore transparent to the user since it is included in that typical of a sliding window and native to common sliding doors (handle rather than single button in the case of motorized openings). Another purpose of this patent is to create a folding threshold which does not require dedicated and additional dynamic contributions to operate but exploits the natural dynamism and mechanical energy deriving from the natural translational motion of opening and closing of the sliding door for its operation. A further purpose of the present patent is to create a folding threshold which can be easily used for newly built doors and without invasive modifications but above all which can be used for existing doors and above all does not require significant modifications to the traditional structures, this allowing it to be applied as additional element and with minimal adaptations to all the sliding doors on the market and, furthermore, it adapts to the different types of installation envisaged for these fixtures (recessed, flush, with raised flooring, etc.). In particular, we want the proposed solution to comply with current regulations concerning architectural barriers (voids, spaces, steps, obstacles, etc.).

The proposed patent achieves the aforementioned objectives through a system with an adaptive threshold in the form of a flap that allows the cavity corresponding to the lower profile of a sliding window to be covered in correspondence with the opening of the sash. Said system subsequently allowing automatic withdrawal of said flap in a side-by-side position and not interfering with the sliding of said door during closing; said automatic withdrawal thus taking place in correspondence with the sliding in the opposite direction of the same door. This double synchronized movement with opening and closing of said sliding door favors the crossing of the threshold by users but above all by wheelchairs, trolleys, pushchairs and similar.

The system referred to in the proposed patent being based on a leverage driven directly by the sliding of said sliding sash which allows automatic movement of said flap from a first horizontal position covering the rail of the frame to a second lateral position alongside the sash sliding, said second position allowing the sash to slide adequately and synchronously along the track when the window is closed. Said flap being subsequently able to return by gravity to the position of cover of the track following the opening of the window, if the sliding sash returns to its fully open position. Said movements of passage from said first cover position of the track to said second sliding position of the sash in the closing phase and vice versa being synchronized by means of a striker anchored to the sliding sash which in its opening and closing movement of the sash determines whether or not this leverage is energized. Said leverage being based on a telescopic mechanism which converts the kinetic energy produced by the advancement of the sash in the closing phase into a vertical movement of a thrust pin which lifts said flap and determines its overturning from the horizontal position covering the track to an oblique and lateral position to the leaf (in favor of gravity for the subsequent return); said position easily and synchronously allowing the sliding of said leaf towards the completely closed position.

Both of these synchronized movements of sash opening with the flap falling by gravity and of sash closing with lifting of the flap in a retracted position and not interfering with lateral sliding, being connected only to the dynamics of movement of the sliding sash regardless of the propulsive and drive modes of the same: both a manual push by a user, and the electromechanical operation of a possible automation system.

### BRIEF DESCRIPTION OF DRAWINGS

Further characteristics and advantages of the proposed technical solution will be more evident in the following description of a preferred, but not exclusive, embodiment, represented, by way of non-limiting example, in the 6 attached tables of drawings wherein:

FIG. 1 and FIG. 2 show in section and side view the elements of the system represented in equilibrium configuration with system at rest, horizontal flap and open sliding door;

FIG. 3 and FIG. 4 are sectional and side views of the elements of the system shown during closing of the door with corresponding tilting of the flap into a position favorable for sliding of the door;

FIG. 5 and FIG. 6 represent in section and in side view the elements of the system during the opening of the door with the corresponding fall of the flap due to gravity.

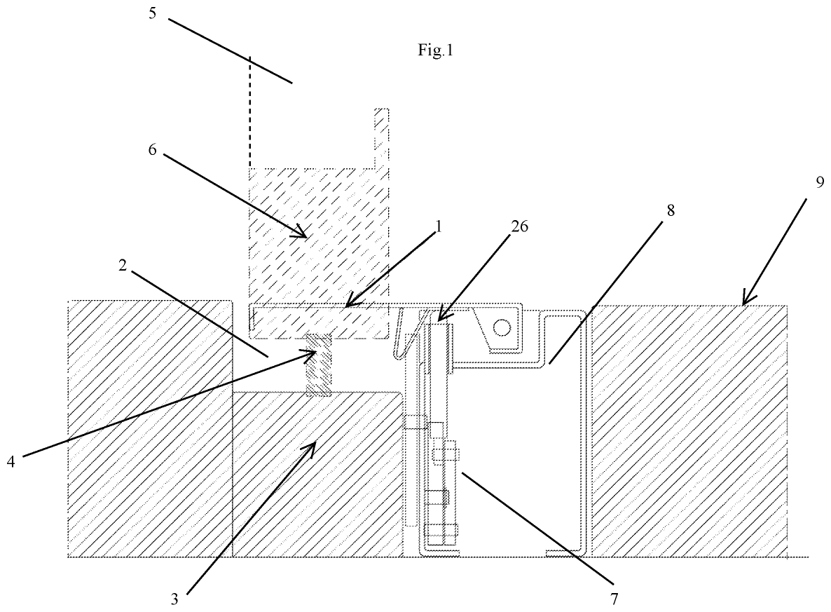

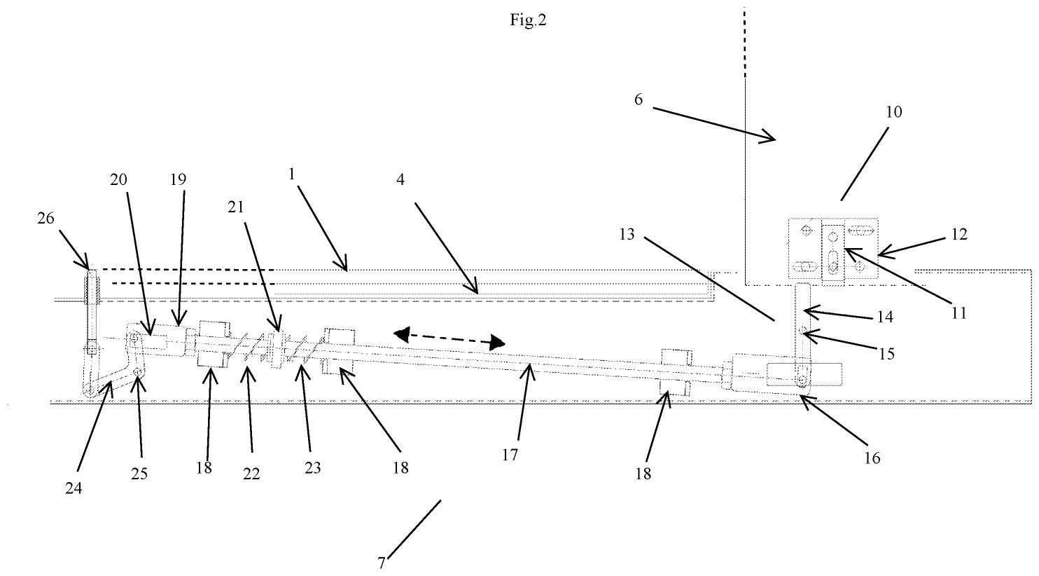

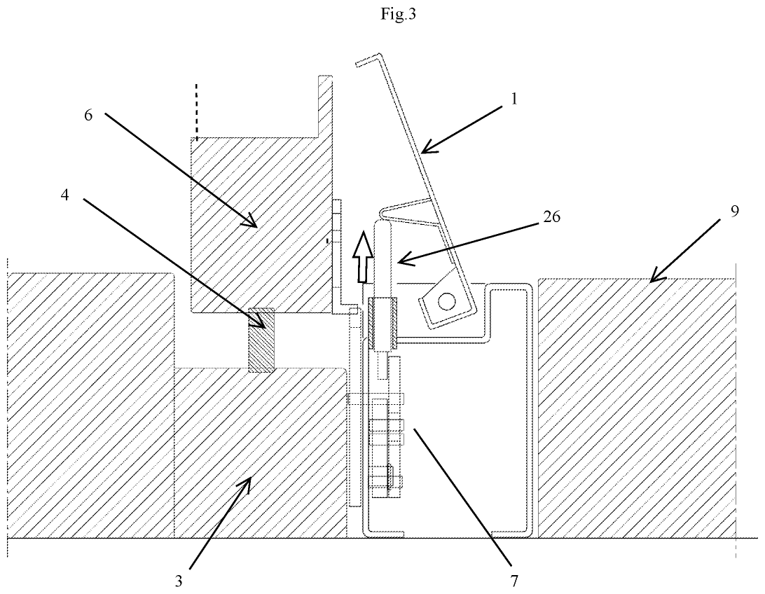

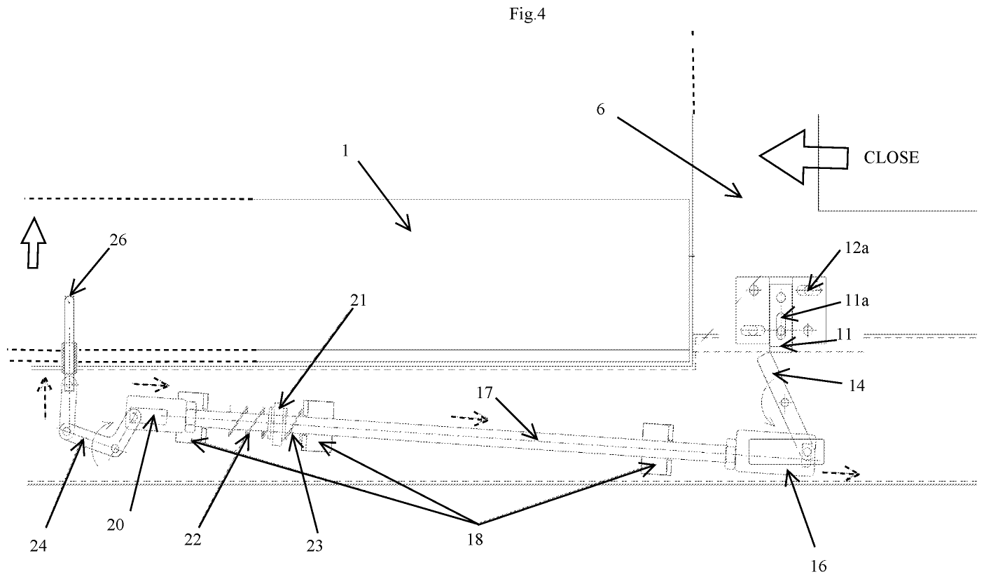

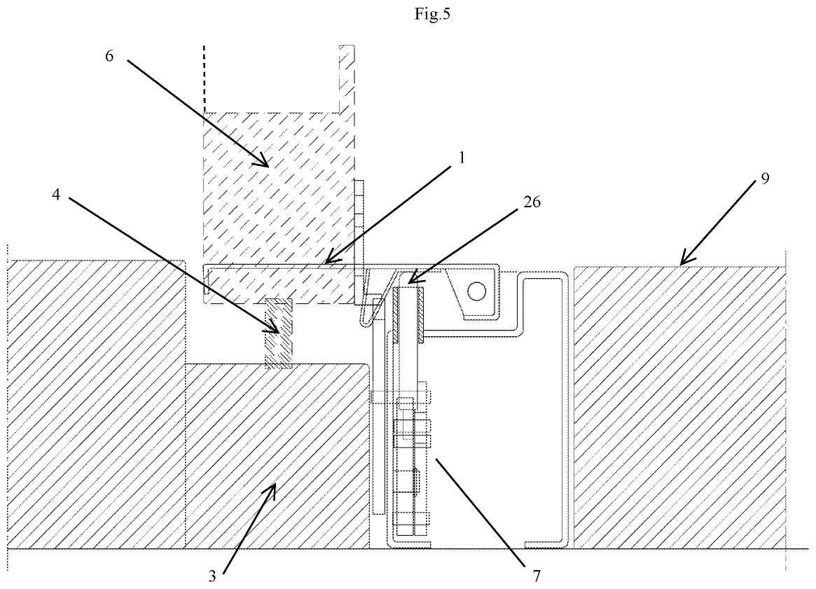

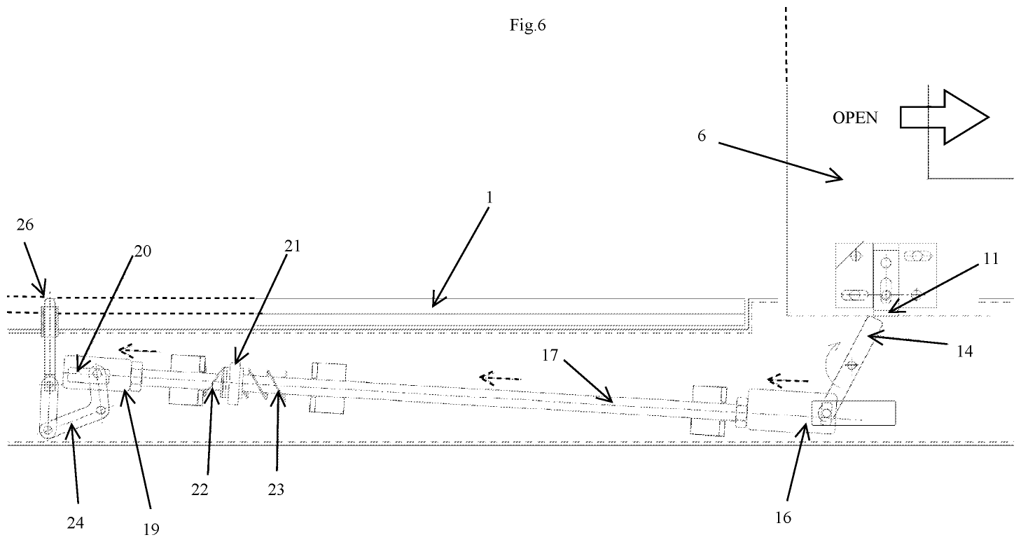

It should be noted that the aforementioned attached figures illustrate only some possible embodiments of the system, in order to better understand the advantages and characteristics described. These embodiments are therefore to be understood as purely illustrative and not limiting to the inventive concept for which protection is requested.

### BEST MODE FOR CARRYING OUT THE INVENTION

With reference to the attached drawings, the adaptive threshold system for sliding doors according to the invention is shown.

Said system comprising a flap (1) used to cover the cavity (2) of the lower profile (3) with track (4) of a sliding door (5); said profile with track being used to guide and facilitate the sliding of at least one sliding door (6) capable of moving between an opening (OPEN) and a closed (CLOSE) position. Said folding flap (1) being operated by means of a leverage (7) contained in a unit (8) having a shape preferably similar to said lower profile (3) of said sliding door (5) and applicable contiguously to the same and, if necessary, recessed with respect to at floor level (9); said leverage (7) being actuated and piloted by the translation motion of said leaf (6) during the common opening (OPEN) and closing (CLOSE) operations of the sliding door (5). Said system allowing to close by gravity and automatically said flap (1) on said profile (3) with rail (4) during the opening of the door (6) and to tilt said flap (1) by means of a pin (26) in when closing the leaf (6) in order to avoid obstructing the sliding of said leaf. Said flap (1) closing on said profile (3) and therefore on the cavity (2) containing said track (4) of the sliding door (5) by simple gravity and overturning in an adjacent and lateral position (therefore not interfering) if said sliding door (6) slides on said track (4) in the act of closing the sliding door (5) and regardless of how this closure is determined (manually or motorized). Said synchronism being determined as anticipated by a suitable leverage (7) which allows during the closing phase of the sliding door (5) to convert the kinetic energy of said leaf (6) into a mechanical impulse which overturns said flap and places it in a position side and alongside the sliding door (6). Said leverage (7) then allowing the gravity fall of said flap (1) if said sliding door (6) returns to an open position. Said leverage (7) comprising:
1. An accessory element (10) made integral with said sliding door (6) and used to exploit the translational motion of said door (6) and transfer it to the actuation mechanism of the flap (1). Said accessory element (10) comprising a contact hook (11) adjustable in height (11a) integral with a plate (12) for hooking to said door (6), said plate (12) being equipped with left and right adjustment means (12a). These adjustments being useful not only to facilitate the application of the system on existing leaves but also to regulate the excitation of the overall system by the sliding leaf (hook point, intensity of the impulse generated on contact).
2. An element (13) for converting translational motion into rotary motion consisting of a transfer lever (14) normally in a vertical position and capable of rotating around a central fulcrum (15); said lever (14) being used to intercept the motion of said contact hook (11) and converting the translational motion of the leaf (6) into a rotary motion used to operate the remaining part of the leverage (7). This transfer between the leaf (6) and the leverage (7) taking place in both directions of the translational motion of the leaf (6) as it slides along the track (4),:
   during the closing phase of the sliding leaf when there is an anti-clockwise rotation of the transfer lever (14) with respect to the fulcrum (15)
   during the opening phase of the sliding leaf (6) when there is a clockwise rotary movement of the lever (14) with respect to the fulcrum (15).
3. A motion converter of the crank rod type (16) connected to said transfer lever (14) and further to an axis (17) supported by suitable brackets (18); said axis (17) being capable of sliding within said brackets (18) and moving left to right and vice versa in correspondence with the movement of said connecting rod converter. Said crank rod converter (16) being used to convert the clockwise and counterclockwise rotary motion of the transfer lever (14) into a translational thrust and traction motion of the axle (17) respectively. Said axle (17) comprising at its opposite end (opposite to the crank connecting rod converter) a connection terminal (19) with the remaining part of the leverage; said connection terminal (19) being characterized by a slot (20).
4. A bush (21) keyed on said axis of movement (17) and on the sides of which there are two springs (22), (23); said springs and said keyed bushing (21) being positioned between two of said axle (17) support brackets (18) so that, as a result of the aforementioned opposite thrust and traction movements of the axle, a first spring (22) goes respectively to compress and the second spring (23) to expand (and vice versa). This alternating and reversible compression and rest mechanism of the springs (22), (23) taking place in correspondence with each of the two directions of translational motion of the axis (17) and thus causing each of said movements (dx sx and vice versa) a reaction contrary to the translation motion of the axis (17) which tends, in the absence of the stimulus provided by the sliding of the leaf, to bring the overall mechanical system back towards a point of equilibrium. Said stimulus being limited in time since it is limited by the short contact time between said contact hook (11) and said transfer lever (14) during the opening and closing phases of the sliding leaf. Said system of springs (22), (23) in push-pull proving particularly useful for restoring the balance of the system whenever the stimulus that the opening or closing of the leaf (6) produces on the leverage (7) ceases.

5. A so-called boomerang connecting rod (24) hinged to a fulcrum (25) and connected at one end to the slot (20) of said terminal (19) and connected to its other end to a thrust pin (26) vertical; said boomerang connecting rod (24) being able to rotate with respect to said fulcrum (25) when solicited by a traction movement of the axle and due to the effect of this rotation and its specific shape, lift said pin (26) upwards by push; this impulsive movement (of the duration of the brief stimulus originally imposed by the dragging of the door (6) on the transfer lever (14) causing the impulsive lifting of the pin (26) and the overturning of the flap (1) in an upright position and alongside the sliding door (6) in a position that does not interfere with the sliding of said door.

As a consequence of the structure described above, the operation of the device can easily be traced back to two states of equilibrium:
Flap (1) lowered to cover the cavity (2) containing said rail (4) in order to facilitate the crossing of the threshold; this condition occurs when the sliding door (5) is fully opened;
Flap (1) in vertical position of stable balance and more precisely in a position alongside the leaf (6) during its sliding during the closing and opening phase of the sliding door (5) or when the leaf (6) is at slide in the portion of the track (4) intended to be covered by the flap (1).

Furthermore, the device according to the proposed patent is characterized by two transition moments between said equilibrium states;
The flap (1) falls due to gravity when the sliding door (5) is fully opened;
The flap (1) is lifted by the thrust pin (26) by means of the leverage (7) by the closing action of the sliding leaf (6) and, particularly, in correspondence with the counterclockwise actuation of the transfer lever (14) when the contact hook (11) integral with said sliding door (6) intercepts said transfer lever (14) during the closing phase of the sliding door (5).

Finally, with reference to the overall functioning of the system, it should be noted that while the closing motion of the sliding leaf (6) produces the lifting of the pin (26), the closing motion does not generate thrust (which would be harmful to the system) but rather favors the repositioning in a lowered and non-interfering position of the pin (26) itself.

This happens because the traction phase of the axle (17) consequent to the counterclockwise rotation of the transfer lever (14) takes place in a direct kinematic chain, with immediate passage of the thrust to the pin (26) while the expansion phase consequent to the clockwise rotation Di said lever (14) is attenuated by the sliding of the terminal (19) with respect to the boomerang connecting rod (24) thanks to the presence of the slot (20). Said sliding preventing the transfer of motion to the pin (26). Said slot (20) and in particular its length being therefore sized to obtain this effect and not actuate the pin (26) which on the contrary can return to its withdrawn position due to the effect of the aforementioned springs (22), (23) which, as mentioned, have the system in equilibrium when any excitation received by the leverage (7) ceases in both directions, both during the opening and during the closing of the sliding door (5).

### INDUSTRIAL APPLICABILITY

While the invention is susceptible to various modifications and alternative constructions, some preferred embodiments have been shown in the drawings and described in detail in the preceding paragraph. It is to be understood, however, that there is no intention to limit the invention to the specific embodiment illustrated, but, on the contrary, it is intended to cover all modifications, alternative constructions, and equivalents which fall within the scope of the invention such as defined in the attached claims.

Use of “for example”, “etc.”, “or” “preferably” indicates non-exclusive alternatives without limitation unless otherwise indicated.

In particular, the invention may be implemented with technical equivalents, with supplementary materials or devices suitable for the purpose and the field of application.

Conformation and sizing of the constituent parts and of the products made to implement the solution the solution may vary in an appropriate manner, but consistent with the proposed solution.

By way of non-limiting example, it should be noted that the dimensions, geometric shapes of the parts involved, their reciprocal positioning and the specific shape and some functions of the system may be further varied: the general layout may in fact be revisited without leaving the ambit of the claimed patent depending on the type of installation and window, said adaptations being required by the field of application and reasonably not available and not even foreseeable at the time of writing of this patent application but nevertheless easily achievable according to the prior art

In any case, said necessary modifications to the system object of the invention and to its characterizing parts, inclusive of adjustments and sizing suitable for the single installation, will be deducible by an adequately trained technician in the sector and without leaving the scope of protection of the claimed patent. Furthermore, the system can be adapted and possibly expanded to provide further and additional services and further equipped with systems and accessories to integrate its operation and increase its potential and areas of use such as for example remote control systems and automatic or motorized activation. Finally, the Applicant reserves and claims the right to protect the invention even if partially implemented.

1. Adaptive threshold for sliding door (5) equipped with at least one sliding leaf (6); said sliding door (6) being capable of passing from an open position (OPEN) to a closed position (CLOSE) by sliding along a track (4) housed in the lower profile (3) of said sliding door (5) said flap (1) being capable of passing from a first horizontal position to said adaptive threshold including at least one flap (1) used to cover a second lateral and inclined position alongside said sliding leaf (6) and being capable of returning by gravity to said first horizontal position; said flap (1) being guided by the movement of said sliding door (6) by means of a leverage (7) housed within a unit (8) applied to the side of said lower profile (3); said leverage (7) further comprising:
at least one contact hook (11) anchored to the lower part of said sliding leaf (6) and dragged during said opening (OPEN) and closing (CLOSE) movements;
a translatory motion converter into rotational motion (13) used to intercept the motion of said contact hook (11) and transfer it to a crank connecting rod converter (16);
an axis (17) provided at the end with a connection terminal (19) comprising a slot (20); said axle (17) being connected to said crank connecting rod converter (16) and being able to slide along at least two support brackets (18);
a bush (21) provided with lateral return springs (22), (23); said bush being keyed on said axis (17) in an intermediate position between two of said support brackets (18);
a boomerang connecting rod (24) connected at its first end with said slot (20) and at its second end with a pin (26); said pin being positioned at rest under the seat of said flap (1) when arranged horizontally.

2. Adaptive threshold according to claim 1 wherein said crank rod converter (16) determines a traction pulse on said axis (17) when said sliding leaf (6) slides towards said closed position (CLOSE).

3. Adaptive threshold according to claim 1 in which said crank rod converter (16) determines a thrust pulse on said axis (17) when said sliding leaf (6) slides towards said opening position (OPEN).

4. The adaptive threshold according to claim 1 wherein said boomerang connecting rod (24) rotates about a fulcrum (25) and vertically lifts said pin (26) when said axis (17) is subjected to traction.

5. Adaptive threshold according to claim 1 wherein said first end of said boomerang connecting rod (24) slides within said slot (20) when said axle (17) is pushed.

6. Adaptive threshold according to claim 1 wherein said contact hook (11) is anchored to said lower part of said sliding leaf (6) by means of a plate (12) equipped with vertical adjustment means (11a) and horizontal adjustment means (12a).

7. Adaptive threshold according to claim 1 wherein said translational to rotational motion converter (13) includes a lever (14) capable of pivoting about a fulcrum (15); said lever (14) being provided with means for vertical realignment.
